(19) United States
(12) Patent Application Publication
(10) Pub. No.: US 2014/0145960 A1
(43) Pub. Date: May 29, 2014

(54) ELECTRONIC APPARATUS, DISPLAY PROCESSING PROGRAM AND DISPLAY PROCESSING METHOD

(71) Applicant: Kabushiki Kaisha Toshiba, Tokyo (JP)

(72) Inventor: Kentaro TAKEDA, Suginami-ku (JP)

(73) Assignee: Kabushiki Kaisha Toshiba, Tokyo (JP)

(21) Appl. No.: 14/011,563

(22) Filed: Aug. 27, 2013

(30) Foreign Application Priority Data
Nov. 29, 2012 (JP) 2012-260838

(51) Int. Cl. G06F 3/041

(52) U.S. Cl. CPC G06F 3/0412
USPC 345/168; 345/173

(57) ABSTRACT

One embodiment provides an electronic apparatus comprising: an acquisition module and a display controller. The acquisition module acquires a proximity state between an edge portion of a touch screen and a pointing body. An image is displayed on the touch screen. A display controller which changes a display position of the image on the touch screen based on the proximity state.

### CROSS-REFERENCE TO RELATED APPLICATION(S)

This application claims priority/priorities from Japanese Patent Application No. 2012-260838 filed on Nov. 29, 2012, the entire contents of which are incorporated herein by reference.

### FIELD

Embodiments described herein relate generally to an electronic apparatus, a display processing program and a display processing method.

### BACKGROUND

To facilitate input operation of a keyboard-including tablet, for example, input operation from a touch screen and input operation from a keyboard may be appropriately switched in accordance with intended purposes.

In a so-called clamshell type keyboard-including tablet, the key board is arranged at a lower side of the touch screen. However, when performing touch operation on the lower side of the touch screen in such clamshell type tablet, keys on the keyboard may become obstacles to the touch operation. Further, the keys on the keyboard may be pushed down by mistake in some cases.

Even in a non-keyboard-including tablet, when the tablet is mounted in a cradle or the like, an outer frame of the cradle may impede touch operation on an edge portion of the touch screen.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates an electronic apparatus according to an embodiment.

FIG. 2 is a block diagram showing functional configuration of the electronic apparatus in FIG. 1.

FIG. 3 illustrates a state in which a user's hand is located on an upper side of a touch screen in the electronic apparatus in FIG. 1.

FIG. 4 illustrates a state in which the user's hand is located on a lower side of the touch screen in the electronic apparatus in FIG. 1.

FIG. 5 is a block diagram showing configuration of a display processing program executed by the electronic apparatus in FIG. 1.

FIG. 6 illustrates a state in which a display position of an image on the touch screen has been changed in the electronic apparatus in FIG. 1.

FIG. 7 illustrates a state in which the user's hand is located on a keyboard in the electronic apparatus in FIG. 1.

FIG. 8 illustrates a state in which a keyboard unit has been detached from the electronic apparatus in FIG. 1.

FIG. 9 is a flow chart for explaining a display processing method executed by the electronic apparatus in FIG. 1.

FIG. 10 illustrates another electronic apparatus different in configuration from the electronic apparatus shown in FIG. 1.

FIG. 11 illustrates a still another electronic apparatus different in configuration from the electronic apparatuses shown in FIGS. 1 and 10.

### DETAILED DESCRIPTION

One embodiment provides an electronic apparatus comprising: an acquisition module and a display controller. The acquisition module acquires a proximity state between an edge portion of a touch screen and a pointing body. An image is displayed on the touch screen. A display controller which changes a display position of the image on the touch screen based on the proximity state.

An embodiment will be described below with reference to the drawings.

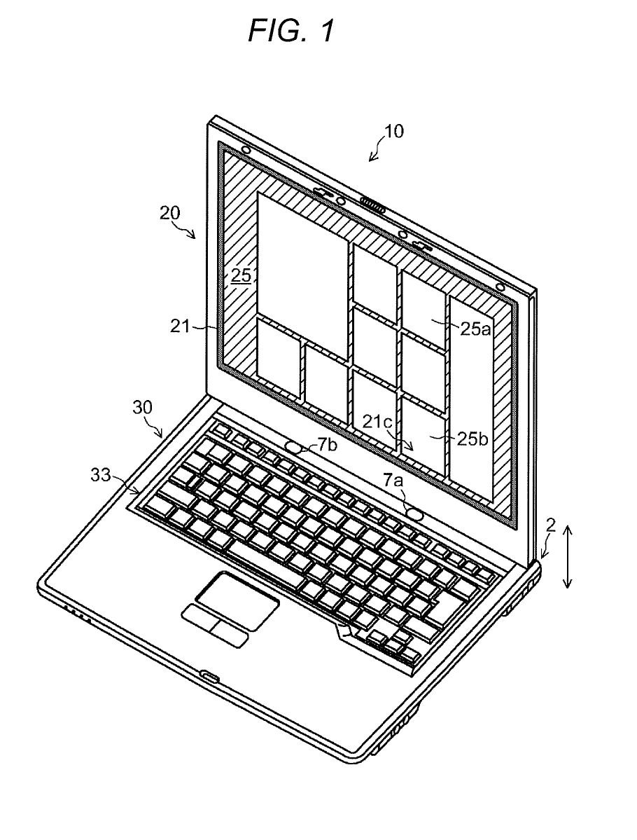

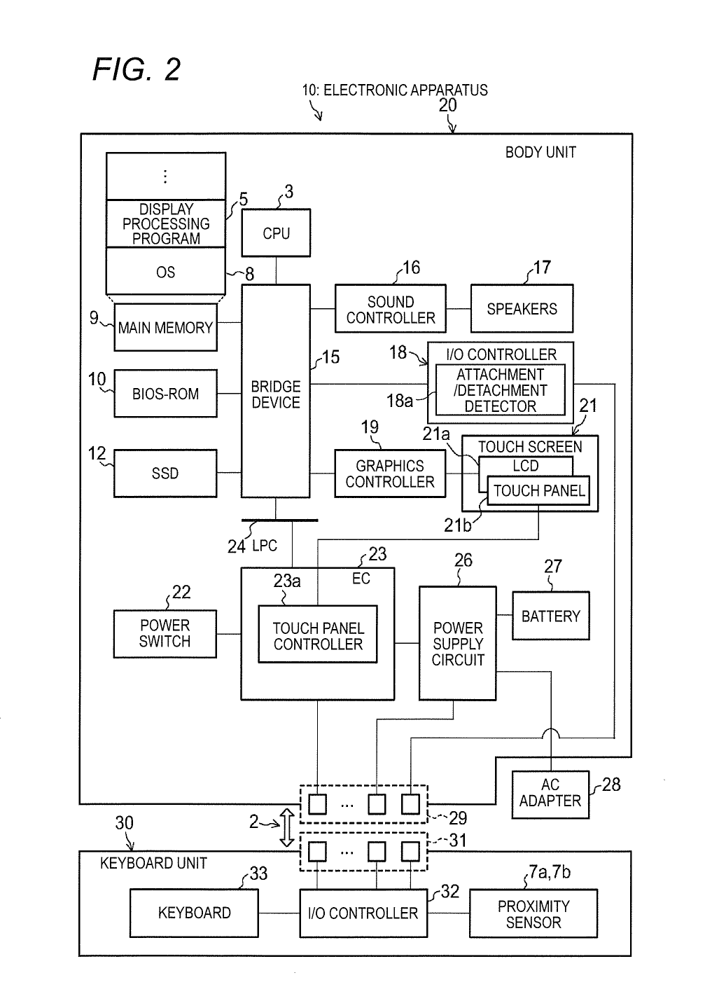

As shown in FIGS. 1 and 2, an electronic apparatus 10 according to the embodiment is a portable type information processing apparatus which is, for example, represented by a keyboard-including tablet or notebook personal computer having a clamshell type structure. The electronic apparatus 10 includes a body unit 20 as a first unit, and a keyboard unit 30 as a second unit. An attachment/detachment mechanism 2 is provided in the electronic apparatus 10. The keyboard unit 30 is detachably attached to the body unit 20 through the attachment/detachment mechanism 2.

As shown in FIG. 2, the body unit 20 mainly includes a CPU (Central Processing Unit) 3, a main memory 9, a BIOS-ROM (Basic Input/Output System-Read Only Memory) 10, an SSD (Solid State Drive) 12, a bridge device 15, a sound controller 16, speakers 17, an I/O (Input/Output) controller 18, a graphics controller 19, a touch screen 21, an embedded controller (EC) 23, a power switch 22, a power supply circuit 26, a battery 27, and a connector 29. In addition, the body unit 20 is formed so that an AC adapter 28 can be connected to the power supply circuit 26.

The CPU 3 is a processor which controls operation of the respective components provided in the electronic apparatus 10. The CPU 3 executes various programs including an OS (Operating System) 8 and a display processing program 5 and loaded from the SSD 12 into the main memory 9. The CPU 3 further executes a BIOS stored in the BIOS-ROM 10. The main memory 9 is a temporary storage region into which the various programs executed by the CPU 3 are read. Various data as well as the OS 8 and the display processing program 5 are stored in the SSD 12.

The bridge device 15 executes communication with each of the sound controller 16, the I/O controller 18 and the graphics controller 19. The bridge device 15 also executes communication with respective devices on an LPC (Low Pin Count) bus 24. In addition, the bridge device 15 has a built-in memory controller which controls the main memory 9.

The sound controller 16 controls operation of the speakers 17 which output sound. The graphics controller 19 controls operation of an LCD (Liquid Crystal Display) 21a which will be described later and which is provided in the touch screen 21. Specifically, the graphics controller 19 uses a storage region of a video memory (VRAM) for executing display processing (arithmetic processing for graphics) to draw display data based on a drawing request inputted from the CPU 3 through the bridge device 15. The graphics controller 19 also stores the display data corresponding to a screen image displayed on the touch screen 21 (LCD 21a) in the video memory.

The touch screen 21 is a touch screen display having the aforementioned LCD 21a and a touch panel (touch sensor) 21b. The touch panel 21b is made of a transparent material and disposed on a front side of the LCD 21a. That is, the touch screen 21 detects a touch area (touch position) on the touch panel 21b (touch screen 21) subjected to a user's touch operation (input operation) with a pointing body such as a pen or a finger, for example, based on resistive or capacitive technology.

As shown in FIG. 1, for example, an image (screen image) 25 containing icon images 25a and 25b for starting up application softwares or the like, a background image, character images, etc. is displayed on the touch screen 21. Various data for generating the aforementioned image 25 are stored in the SSD 12.

When an external power supply is fed through the AC adapter 28, the power supply circuit 26 generates a system power source to be supplied to the respective components of the electronic apparatus 10 by using the external power supply fed through the AC adapter 28. On the other hand, when the external power supply is not fed through the AC adapter 28, the power supply circuit 26 generates a system power source to be supplied to the respective components of the electronic apparatus 10 by using the battery 27.

The embedded controller 23 powers on/off the body unit 20 of the electronic apparatus 10 in accordance with a user's operation of the power switch 22. The embedded controller 23 is always active regardless of whether the body unit 20 of the electronic apparatus 10 is powered on or off. That is, the embedded controller 23 controls operation of the power supply circuit 26.

The embedded controller 23 has a touch panel controller 23a which controls operation of the touch panel 21b. The touch panel controller 23a notifies the CPU 3 of touch information acquired from the touch panel 21b through the bridge device 15. The CPU 3 instructs the graphics controller 19 to make display control in accordance with the touch information.

For example, the I/O controller 18 serves as a USB (Universal Serial Bus) controller. The I/O controller 18 is connected to the connector 29 through a bus signal line. When the connector 29 is coupled to a keyboard unit 30 side connector 31 which will be described later, the I/O controller 18 transmits/receives various data and control signals to/from a keyboard unit 30 side I/O controller 32 (which will be described later) through the connectors 29 and 31 and the bus signal line.

The I/O controller 18 has an attachment/detachment detector 18a which detects whether the connector 29 is coupled to the keyboard unit 30 side connector 31 through the attachment/detachment mechanism 2 or not. Specifically, the attachment/detachment detector 18a detects whether the keyboard unit 30 is attached to the body unit 20 or whether the keyboard unit 30 is detached from the body unit 20.

On the other hand, the keyboard unit 30 has a keyboard 33, proximity sensors 7a and 7b, the aforementioned connector 31, and the aforementioned I/O controller 32. The keyboard 33 accepts a user's key operation, and outputs an instruction command corresponding to the operated key to the I/O controller 32.

The I/O controller 32 controls the keyboard 33 and the proximity sensors 7a and 7b. When the connector 29 is coupled to the connector 31, the I/O controller 32 is connected to the power supply circuit 26 on the body unit 20 side to thereby be supplied with electric power to enable the keyboard 33 to be operated to give a key input.

For example, each of the proximity sensors 7a and 7b emits an electromagnetic wave, an ultrasonic wave or the like, and measures a return time of the reflection wave reflected by a surface of an object to thereby detect a distance between the proximity sensor 7a or 7b and the object. The proximity sensors 7a and 7b are disposed at an upper surface of the keyboard unit 30 and in front of a region where the body unit 20 is attached to keyboard unit 30.

Specifically, in the state in which the thin plate-shaped body unit 20 is raised with respect to the thin plate-shaped keyboard unit 30, each of the proximity sensors 7a and 7b detects an object located in a front side of the body unit 20 along a direction from a lower portion to an upper portion of the body unit 20.

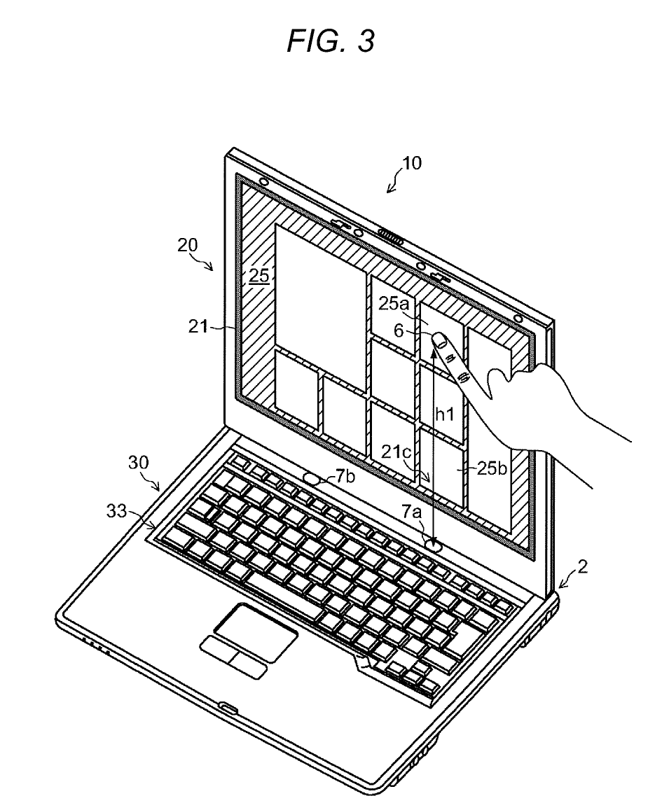

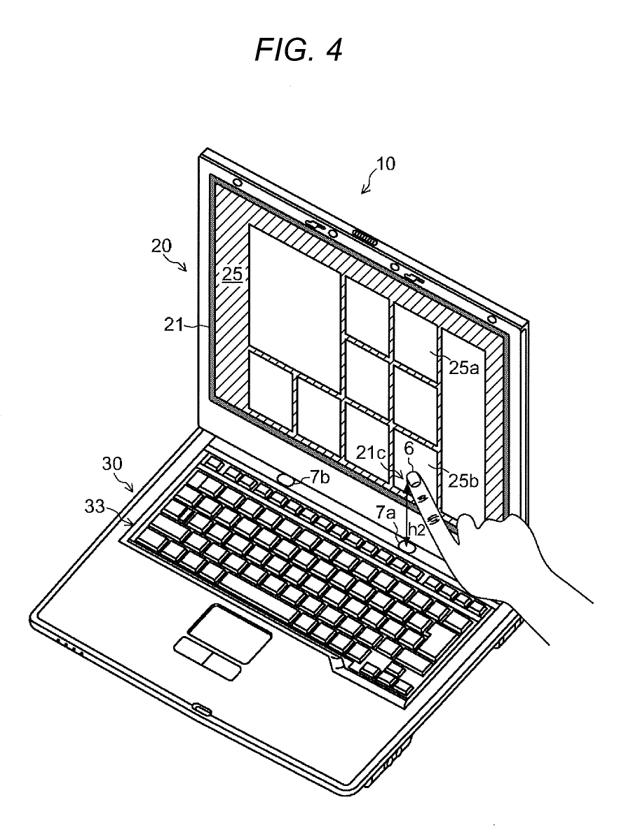

As shown in FIGS. 3 and 4, each of the proximity sensors 7a and 7b detects a distance between the front side lower portion of the body unit 20 and a user's hand (or a pointing body 6 itself such as a pen or finger tip) performing a touch operation on the touch screen 21. The proximity sensor 7a is a right hand detecting proximity sensor whereas the proximity sensor 7b is a left hand detecting proximity sensor. In this embodiment, the lower side of the touch screen 21 and the keyboard 33 are disposed so as to approach each other.

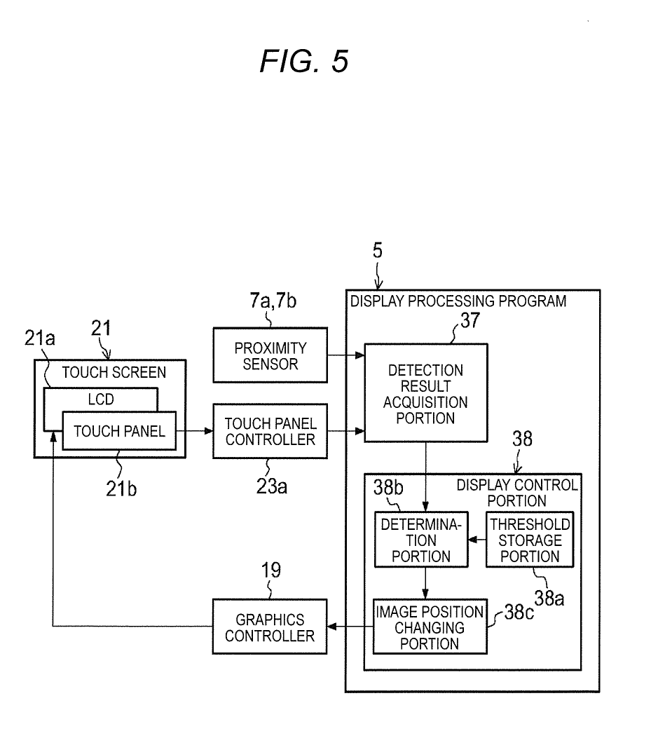

The display processing program 5 will be described below. As shown in FIG. 5, the display processing program 5 has a detection result acquisition portion 37 and a display control portion 38 which are achieved by software. The CPU 3 executing the detection result acquisition portion 37 may function as an acquisition module, and the CPU 3 executing the display control portion 38 may function as a display controller. The detection result acquisition portion 37 acquires a detection result of a contact state between a pointing body such as a finger or a pen and the touch screen 21. For example, the detection result acquisition portion 37 receives, as an input, data based on an input operation on the touch panel 21b through the touch panel controller 23a.

As shown in FIG. 1, the detection result acquisition portion 37 further acquires a detection result of a proximity state between an edge portion 21c of the touch screen 21 having the displayed image 25 and the pointing body 6 such as a finger and a pen, from each of the proximity sensors 7a and 7b. Each of the proximity sensors 7a and 7b outputs a signal corresponding to the distance of the proximity between the edge portion 21c and the pointing body 6. Specifically, the detection result acquisition portion 37 acquires a detection result of a proximity state between the pointing body 6 and specific one (a bottom portion in the embodiment) of four sides forming vertical and horizontal edges of the touch screen 21, from each of the proximity sensors 7a and 7b. As shown in FIG. 1, in this embodiment, the keyboard 33 is disposed on the side of the aforementioned specific side.

On the other hand, the display control portion 38 controls the graphics controller 19 to change the display position of the image 25 on the touch screen 21 based on the detection result of the proximity state between the edge portion 21c of the touch screen 21 and the pointing body 6, acquired by the detection result acquisition portion 37. Specifically, the display control portion 38 has a threshold storage portion 38a, a determination portion 38b, and an image position changing portion 38c.

The threshold storage portion 38a reads a threshold corresponding to the distance of the proximity between the edge portion 21c of the touch screen 21 and the pointing body 6, for example, from the SSD 12, and stores the threshold. The determination portion 38b determines whether the distance of the proximity between the edge portion 21c (the bottom portion of the touch screen 21) and the pointing body 6 is larger than the threshold or not, based on the detection results of the proximity states detected by both the proximity sensors 7a and 7b and acquired by the detection result acquisition portion 37. That is, the determination portion 38b determines whether the pointing body 6 is to touch the edge portion 21c of the touch screen 21 in the next moment or not.

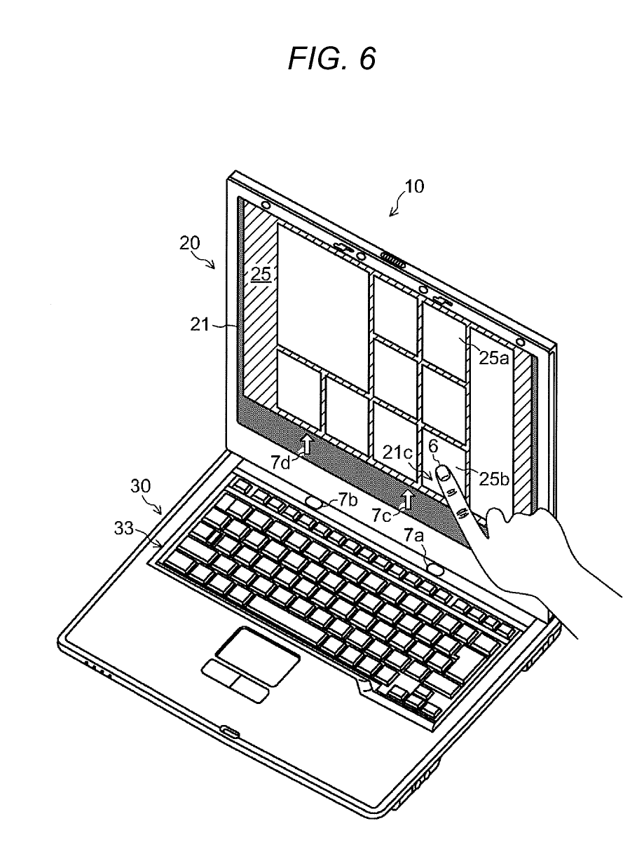

When the determination portion 38b makes determination that the distance h2 of the proximity between the edge portion 21c and the pointing body 6 is not larger than the threshold as shown in FIG. 4, the image position changing portion 38c changes the display position of the image 25 in a direction to move the image 25 away from the edge portion 21c (the keyboard 33 side) as a subject of detection of the proximity state (toward the upper portion of the touch screen 21) as shown in FIG. 6.

In this manner, even when the lower side of the touch screen 21 is to be subjected to touch operation, the image 25 moves toward the upper portion of the touch screen 21 so that keys on the keyboards 33 can be prevented from impeding touch operation or from being pushed down by mistake. That is, the threshold corresponding to the distance of the aforementioned proximity is set at a value allowed to avoid physical interference with the keys at the time of touch operation. In addition, the image position changing portion 38c moves the display position of the whole display screen on the touch screen 21 so that, for example, the arrangement of icons for execution of applications remains unchanged.

When the display position of the image 25 is changed in a direction to move the image 25 away from the edge portion 21c as a subject of detection of the proximity state, the display control portion 38 including the image position changing portion 38c displays (for example, animates) guidance information 7c and 7d such as arrow images for guiding change (movement) of the display position of the image 25 on the touch screen 21 as shown in FIG. 6. In this manner, the user can be notified of the movement of the display position of the image 25 so that, for example, the user can be prevented from making a touch operation etc. in a wrong position on the touch screen 21. Incidentally, voice may be outputted from the speakers 17 to thereby guide the movement of the display position of the image 25.

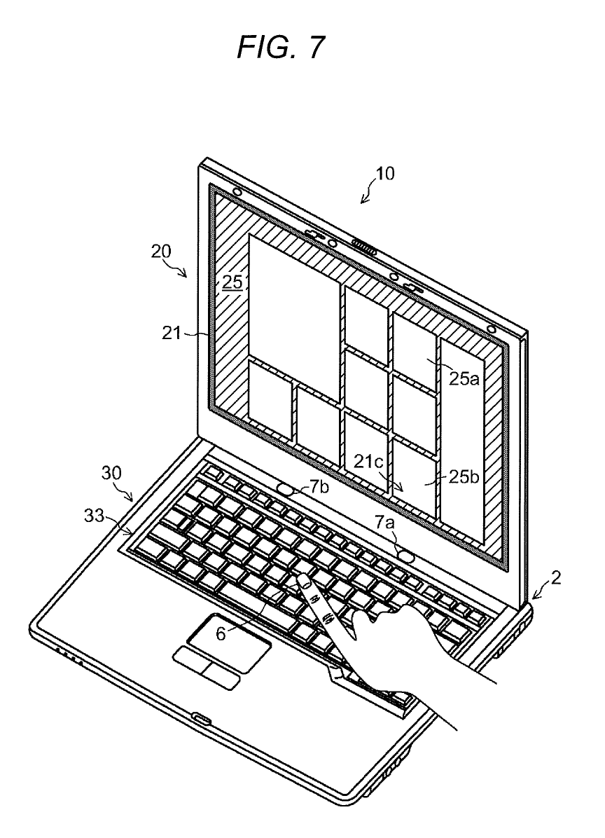

In addition, when the determination portion 38b makes determination that the distance h1 of the proximity between the edge portion 21c of the touch screen 21 and the pointing body 6 is larger than the threshold as shown in FIG. 3, the display control portion 38 does not change the display position of the image 25 because the keys on the keyboard 33 do not impede touch operation. Moreover, when the pointing body 6 is located on the keyboard 33 so that detection results cannot be obtained by the proximity sensors 7a and 7b as shown in FIG. 7, the display control portion 38 does not change the display position of the image 25 because determination is made that touch operation will not occur.

Even if determination is made that the distance h2 of the proximity between the edge portion 21c of the touch screen 21 and the pointing body 6 is not larger than the threshold as shown in FIG. 4, the display control portion 38 still invalidates control of changing the display position of the image 25 when another determination is made that the pointing body 6 comes into contact with the touch screen 21 based on a detection result of the contact state acquired by the detection result acquisition portion 37 at the time of the first-mentioned determination.

That is, when the touch operation is a drag operation for performing tracing on the touch screen 21, the control made by the display control portion 38 is control for preventing wrong operation from being caused by the movement of the display position of the image 25.

In addition, when determination is made that the pointing body 6 comes into contact with the touch screen 21 based on a detection result of the contact state acquired by the detection result acquisition portion 37 in the state in which the display position of the image 25 has been changed as shown in FIG. 6, and determination is then made that the contact state is cancelled, the display control portion 38 makes control to restore the changed display position of the image 25 to its initial display position as shown in FIG. 1.

The control made by the display control portion 38 is control for displaying the whole display screen on the touch screen 21 and setting the touch screen 21 to wait for a next touch operation as shown in FIG. 1, under the determination that the user's touch operation is once terminated.

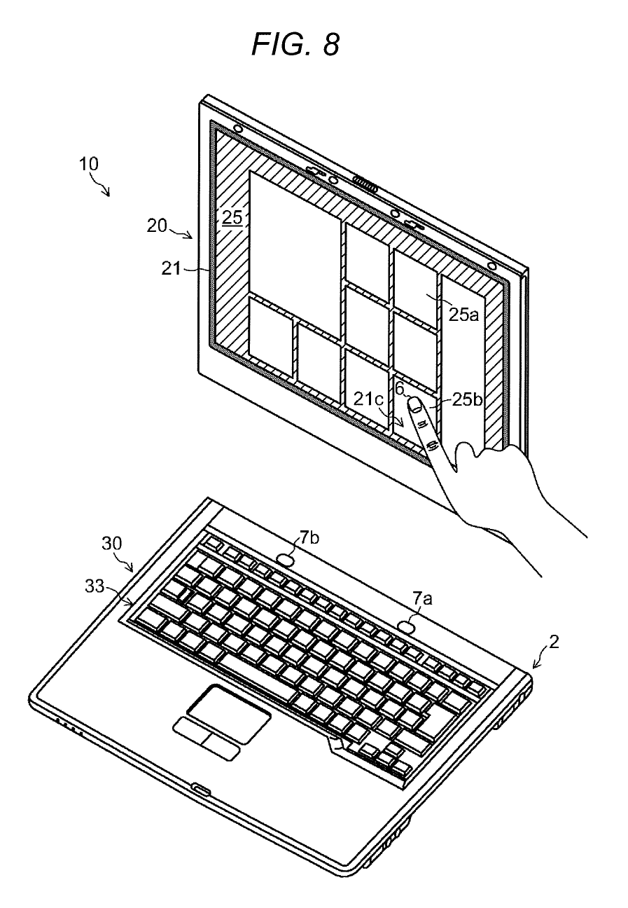

When the attachment/detachment detector 18a detects detachment of the keyboard unit 30 from the body unit 20 as shown in FIG. 8, the display control portion 38 invalidates control of changing the display position of the image. The control made by the display control portion 38 is control for removing unnecessary processing because the keyboard unit 30 is detached so that key input is disabled in the keyboard 33 not supplied with any electric power, and that there is no fear that the keys on the keyboard 33 will impede touch operation when, for example, the lower portion of the touch screen 21 is to be subjected to touch operation.

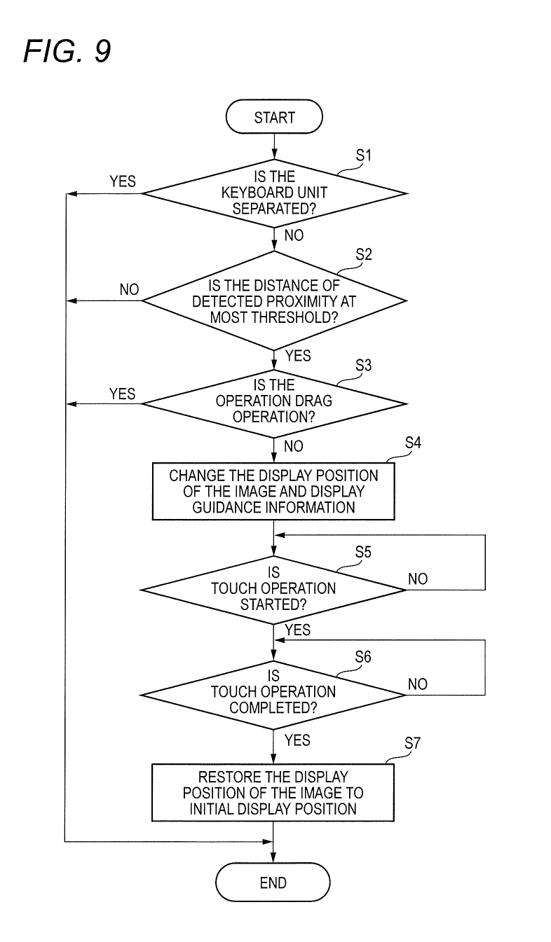

Next, a display processing method executed by the electronic apparatus 10 will be described with reference to a flow chart shown in FIG. 9.

First, the display control portion 38 makes determination as to whether the keyboard unit 30 is detached from the body unit 20 or not, based on a detection result acquired by the attachment/detachment detector 18a (S1). When determination is made that the keyboard unit 30 is not detached (NO in S1), the display control portion 38 makes determination as to whether the distance of the proximity between the edge portion 21c of the touch screen 21 and the pointing body 6 is larger than the threshold or not, based on detection results of the proximity state detected by the proximity sensors 7a and 7b and acquired by the detection result acquisition portion 37 (S2).

When determination is made that the distance h2 of the aforementioned proximity is not larger than the threshold as shown in FIG. 4 (YES in S2), the display control portion 38 further makes determination as to whether the touch operation is a drag operation or not. When determination is made that the touch operation is not a drag operation (NO in S3), the display control portion 38 changes (moves) the display position of the image 25 on the touch screen 21 and displays the guidance information 7c and 7d on the touch screen 21 as shown in FIG. 6 (S4).

When determination is made that the pointing body 6 comes into contact with the touch screen 21 based on a detection result of the contact state acquired by the detection result acquisition portion 37 in the state in which the display position of the image 25 has been changed as shown in FIG. 6 (YES in S5) and determination is then made that the contact state is cancelled (YES in S6), the display control portion 38 makes control to restore the changed display position of the image 25 to the initial display position as shown in FIG. 1 (S7).

Incidentally, processing concerned with the aforementioned steps S6 and S7 may be partially changed. For example, the display control portion 38 may keep the display position of the image 25 changed unless determination is made that the contact state between the touch screen 21 and the pointing body 6 is cancelled. However, when determination is made that the contact state is cancelled (YES in S6), the display control portion 38 may not restore the display position of the image 25 to the initial display position immediately but shift the processing flow to Step S7 for restoring the display position of the image 25 to the initial display position only when determination is made that the contact state is cancelled and that the distance of the proximity between the edge portion 21c of the touch screen 21 and the pointing body 6 is larger than the threshold.

As described above, in the electronic apparatus 10 according to the embodiment, when determination is made that the edge portion 21c (the bottom portion) of the touch screen 21 is then subjected to touch operation by the pointing body 6 such as a pen or a finger based on detection results acquired from the proximity sensors 7a and 7b, the display position of the image 25 on the touch screen 21 is moved in a direction to move the image 25 away from the keyboard 33 side.

Hence, according to the electronic apparatus 10, the lower side of the touch screen 21 which is hardly subjected to touch operation because it is near to the position of the keyboard 33 need not be subjected to touch operation, so that input operation can be made without any obstruction.

Although some embodiments of the invention have been described above, these embodiments are presented by way of example with no intention of limiting the scope of the invention. These novel embodiments may be carried out in various other modes. Various omissions, replacements or changes may be made without departing from the gist of the invention. These embodiments and modifications thereof are contained in the scope and gist of the invention and contained in the scope of the invention described in the scope of Claims and its equivalents.

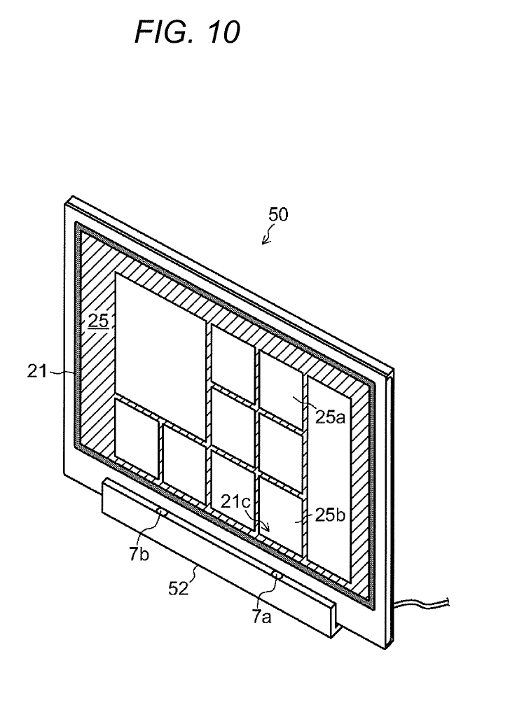

Although a keyboard-including tablet is exemplified as the electronic apparatus 10 in the aforementioned embodiments, the display processing program 5 may be given to an electronic apparatus 50 of a keyboard-excluding tablet as shown in FIG. 10. For example, a use mode in which the electronic apparatus 50 is mounted in a cradle 52 provided with the proximity sensors 7a and 7b may be assumed in this case. However, the display position of the image 25 may be changed by the display processing program 5 so that the outer frame of the cradle 52 can be prevented from impeding touch operation.

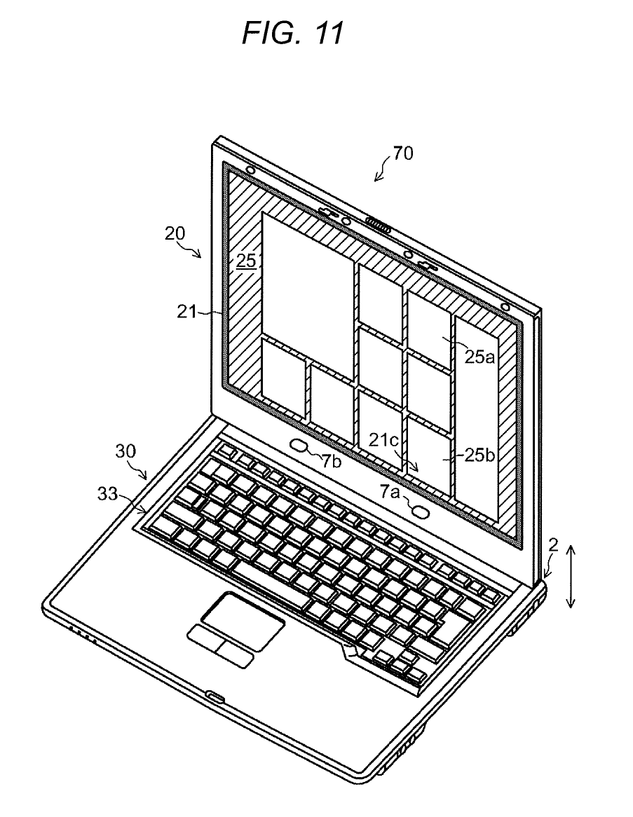

Moreover, an electronic apparatus 70 including the proximity sensors 7a and 7b provided on the body unit 20 side may be formed as shown in FIG. 11. In addition, the proximity sensors 7a and 7b may be replaced with keys on the keyboard 33 or button images displayed on the touch screen 21 so that the display position of the image on the touch screen 21 can be changed when the keys on the keyboard 33 or the button images are pushed down.

A hinge mechanism or the like may be added to the electronic apparatus 10 according to the aforementioned embodiment so that the arrangement of the keyboard unit 30 and the body unit 20 can be modified so that they face each other. Although the aforementioned detection result acquisition portion 37 and the aforementioned display control portion 38 are achieved by software, they may be achieved by hardware made of combination of electronic components.

1. An electronic apparatus comprising:
an acquisition module which acquires a proximity state between an edge portion of a touch screen and a pointing body, an image being displayed on the touch screen; and
a display controller which changes a display position of the image on the touch screen based on the proximity state.

2. The electronic apparatus of claim 1,
wherein the proximity state comprises a proximity distance between the edge portion and the pointing body, and
wherein, when the proximity state indicates that the proximity distance is equal to or smaller than a threshold, the display controller changes the display position of the image in a direction to move the image away from the edge portion.

3. The electronic apparatus of claim 1,
wherein, the display controller displays guidance information on the touch screen to guide a change of the display position of the image.

4. The electronic apparatus of claim 2,
wherein the acquisition module further acquires a contact state between the touch screen and the pointing body, and
wherein the display controller invalidates changing the display position of the image when the contact state indicates that the pointing body comes into contact with the touch screen, even if the proximity state indicates that the proximity distance is equal to or smaller than the threshold.

5. The electronic apparatus of claim 1,
wherein the acquisition module further acquires a contact state between the touch screen and the pointing body, and
wherein, in a state in which the display position of the image has been changed, the display controller restores the changed display position of the image into an initial display position when the contact state indicates that a contact between the pointing body and the touch screen is made and then cancelled.

6. The electronic apparatus of claim 1,
wherein the acquisition module acquires the proximity state between the pointing body and specific one of four sides forming vertical and horizontal edge portions of the touch screen, and
wherein the display controller changes the display position of the image in a direction to move the image away from the specific side when the proximity state indicates that a proximity distance between the specific side and the pointing body is equal to or smaller than a threshold.

7. The electronic apparatus of claim 6, further comprising:
a keyboard disposed on the specific side of the touch screen.

8. The electronic apparatus of claim 1, further comprising:
a first unit having the touch screen; and
a second unit having a keyboard, the second unit being detachably attached to the first unit,
wherein the display controller invalidates changing the display position of the image when the second unit is detached from the first unit.

9. The electronic apparatus of claim 1, further comprising:
at least one sensor which outputs a signal corresponding to the proximity state.

10. A display processing program for causing a computer to function as:
an acquisition module which acquires a proximity state between an edge portion of a touch screen and a pointing body, an image being displayed on the touch screen; and
a display controller which changes a display position of the image on the touch screen based on the proximity state.

11. A display processing method comprising:
acquiring a proximity state between an edge portion of a touch screen and a pointing body, an image being displayed on the touch screen; and
changing a display position of the image on the touch screen based on the proximity state.
